(19) United States
(12) Patent Application Publication
(10) Pub. No.: US 2022/0000038 A1
(43) Pub. Date: Jan. 6, 2022

(54) GRAFT SYSTEM

(71) Applicant: VISSER 'S-GRAVENDEEL HOLDING B.V., 's-Gravendeel (NL)

(72) Inventor: Anthony VISSER, 's-Gravendeel (NL)

(73) Assignee: VISSER 'S-GRAVENDEEL HOLDING B.V., 's-Gravendeel (NL)

(21) Appl. No.: 17/299,510

(22) PCT Filed: Dec. 3, 2019
(86) PCT No.: PCT/NL2019/050805

§ 371 Date: Jun. 3, 2021

(30) Foreign Application Priority Data
Dec. 6, 2018 (NL) 2022145

(51) Int. Cl. A01G 2/32

(52) U.S. Cl. CPC A01G 2/32

(57) ABSTRACT

A graft system configured to graft plant material, including a first holder configured to engage a stem of a first plant below a cutline to hold a severed stem and connected roots of the first plant, and a second holder configured to engage a stem of a second plant above a cut line to hold a severed stem and connected leaves of the second plant. The second holder is stackable on the first holder to abut and align the severed stems. A strip embodying a graft system as well as an assembly of a strip or graft system with a tray.

The present disclosure relates to a graft system.

To the best knowledge of the inventors of the present disclosure, the state of the art comprises a process where a worker manually cuts the stems of a first plant and of a second plant. After cutting, the worker places the severed stem of the first plant with the roots thereof attached to the stem, but the leaves removed, against the severed stem of the second plant with the leaves thereof attached to the stem, but the roots removed. Subsequently, a clip is manually applied at and more in particular on or over the interface of the severed stems to keep the severed stems together and allow the grafting to take place, wherein the stems literally grow attached to one another.

This manual technique is cumbersome and labor intensive. Moreover, a worker is never sure that the stems abut and are aligned or that the clip is arranged correctly, since this is hidden from sight by the clip on/over the interface between the severed stems.

The inventors of the present disclosure have set out to invent a solution that allows automation to obviate the cumbersome and labor intensive prior technique, while increasing the graft success rate.

To this end a graft system is provided, which is configured to graft plant material, and comprises: a first holder configured to engage a stem of a first plant, below a cutline to hold a severed stem and connected roots of the first plant; and a second holder configured to engage a stem of a second plant, above a cut line to hold a severed stem and connected leaves of the second plant; wherein the second holder is stackable on the first holder, to thereby abut and align the severed stems.

The stackable holders allow automatic manipulation and processing. A cut may be an automated laser cut, after which the second holders may be engaged by a manipulator, such as a robot arm, to be stacked on the first holders.

Preferred but non-limiting embodiments may become apparent from the below embodiment description and/or be defined in the appended dependent claims.

In a potential embodiment, a grail system according to the present disclosure may exhibit features that at least one of the first holder and the second holder comprises a stem compressing clamp. Preferably a size of the stem compressing clamp is uniform for grafting any particular combination of first and second plants. This obviates a need to select which stems of first and second plants are, based on the respective sizes and in particular stem diameters thereof, best suited to be grafted. Needless to say, such a selection is also with the realm of possibilities within the scope of protection to the present disclosure.

In a potential additional or alternative embodiment, a graft system according to the present disclosure may exhibit features that at least one of the first holder and the second holder is connected to a carrier. This enables that either the holder or the carrier is engaged by automatic manipulation means, such as a robot arm or the like.

In a potential additional or alternative embodiment, a graft system according to the present disclosure may exhibit features that at least one of the first holder and the second holder is releasably supported on one of a post and another holder. Thereby the stackability is enhanced, and/or an embodiment may be provided wherein the holder is maintained at a suitable grafting height relative to the stem on the post.

In an embodiment of a graft system with a carrier and a releasable support of one of the holders on a post or other holder, the carrier of the at least one of the first and second holder may be supported on the one of the post and the other holder.

In an embodiment of a graft system with a carrier, wherein the at least one of the first and second holder may be connected to two carriers. More than two carriers are also possible. In such an embodiment the holder may be arranged between the two carriers. This may allow for a higher degree of stability for the holder, where alternatively a single carrier per holder may save material and still allow sufficient stability for example when comprising a non-round hole for inserting either a non-round post or non-round other holder. Non-round cross sectional shapes may alow for the sought degree of stability as well as maintain a desired orientation of the holder relative to the carrier.

In a potential additional or alternative embodiment, a graft system according to the present disclosure may be manufactured at least partially from bio-degradable material. This allows the graft system to be degraded without waste, but reusable systems may also prove feasible within the scope of protection for the present disclosure according to appended claims, but care should always be taken to avoid passing on of contaminations when deploying a re-usable system. Moreover, when an embodiment is based on cutting a holder loose from any support, post, carrier, or the like, re-usability may be lost and then a bio-degradable material may be the preferred choice.

The present disclosure also relates to a strip to—in use—accommodate plant material, comprising: an array of root accommodations; and at least a portion of a graft system according to any one of the preceding claims. Each of the root accommodations may have a corresponding portion of the graft system. Portions of the graft system may be interlinked to allow simultaneous manipulation of a series of such graft system portions, relative to the root accommodations.

The post may extend from at least one of the root accommodations.

The at least one carrier may be manufactured as an integral component of a post to be severed together with the stem.

The present disclosure also relates to an assembly of a tray and one of a graft system according to the present disclosure and a strip according to the present disclosure, wherein the tray comprises plant positions defined by indentations configured to contain at least one of substrate and plant roots.

Following the above reference to aspects of the present disclosure in terms and expressions of the appended claims, below an embodiment description is provided with reference to the appended drawing exhibiting potential embodiments of the present disclosure, to which the scope of protection for the present disclosure is by no means limited and may even encompass, in particular for specific juris dictions alternatives for aspects and features of appended independent claims. In distinct figures of the appended drawing the same or similar reference signs may be used to identify the same or similar features, aspects, element, components and functional groups thereof, even if referenced in relation to distinct embodiments. In the drawing:

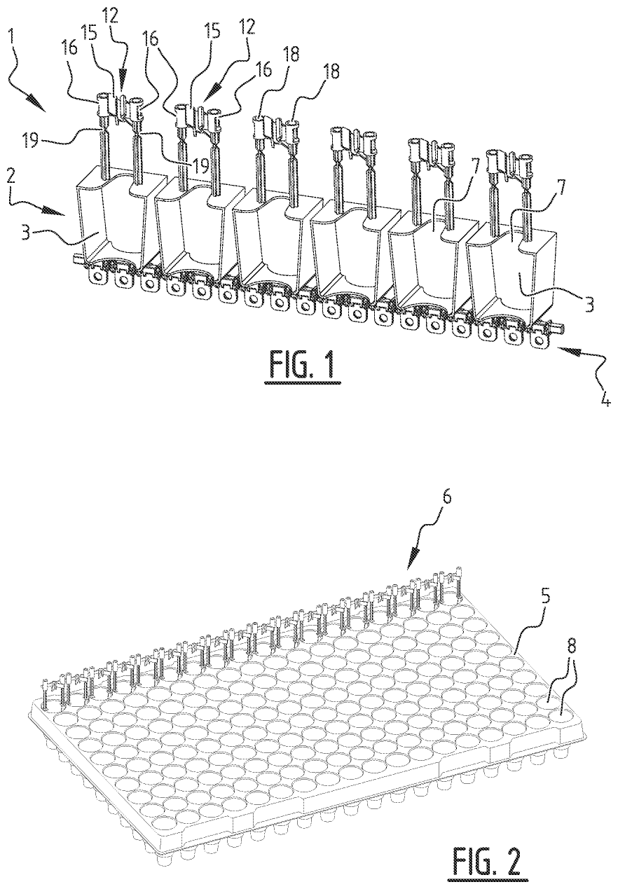

FIG. 1 shows an embodiment of a strip having a graft system, allowing automatic processing and/or manipulation;

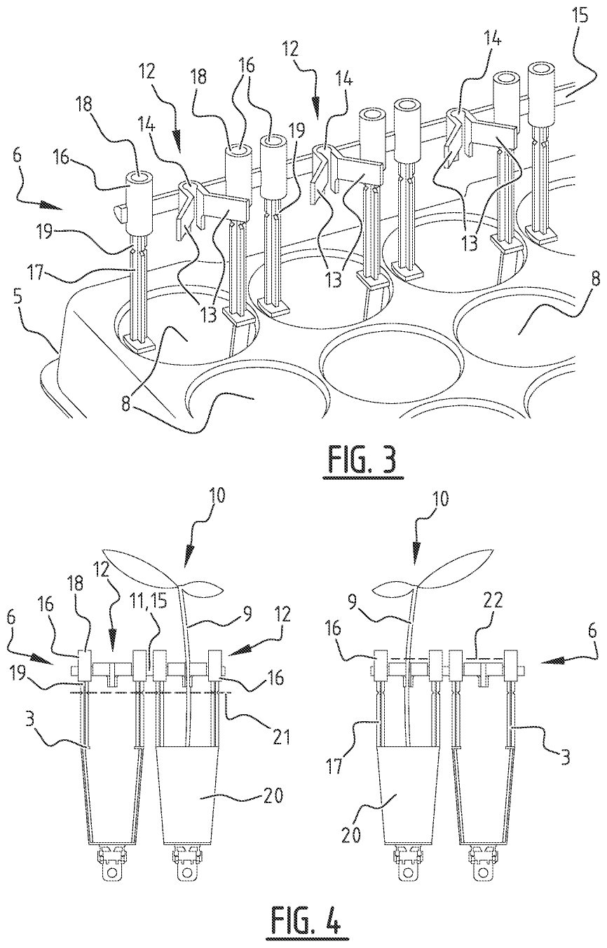

FIGS. 2 and 3 shows an embodiment of a strip of FIG. 1 in an assembly with a tray;

FIGS. 4-6 show an embodiment of successive steps in a grafting process employing a graft system with strips according to the present disclosure;

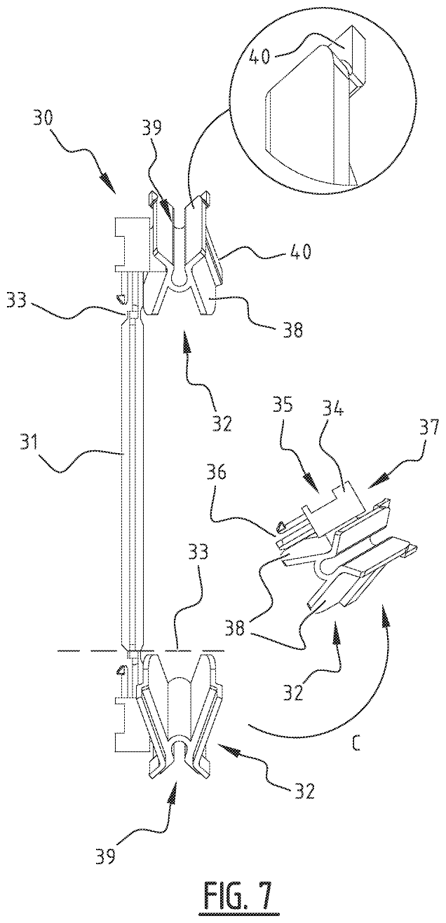

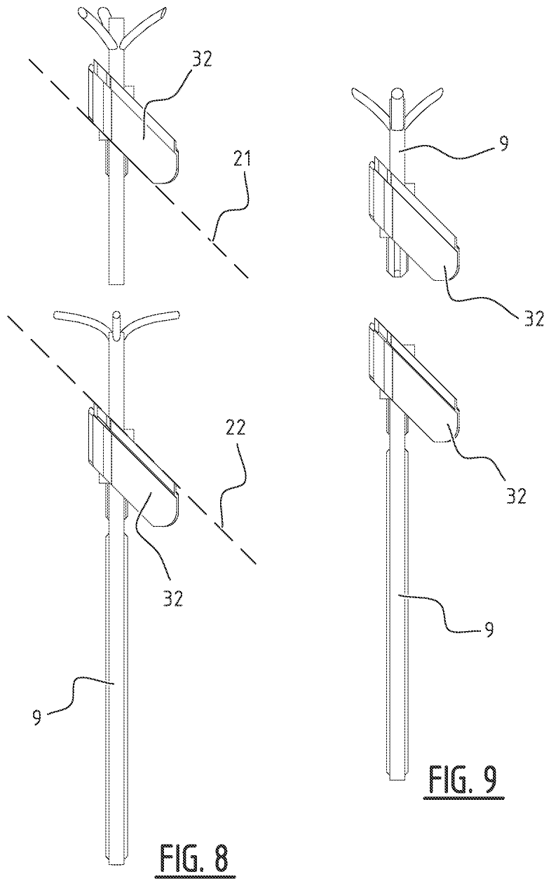

FIGS. 7-11 show an alternative embodiment of a grafting system according to the present disclosure and a manner of use thereof; and

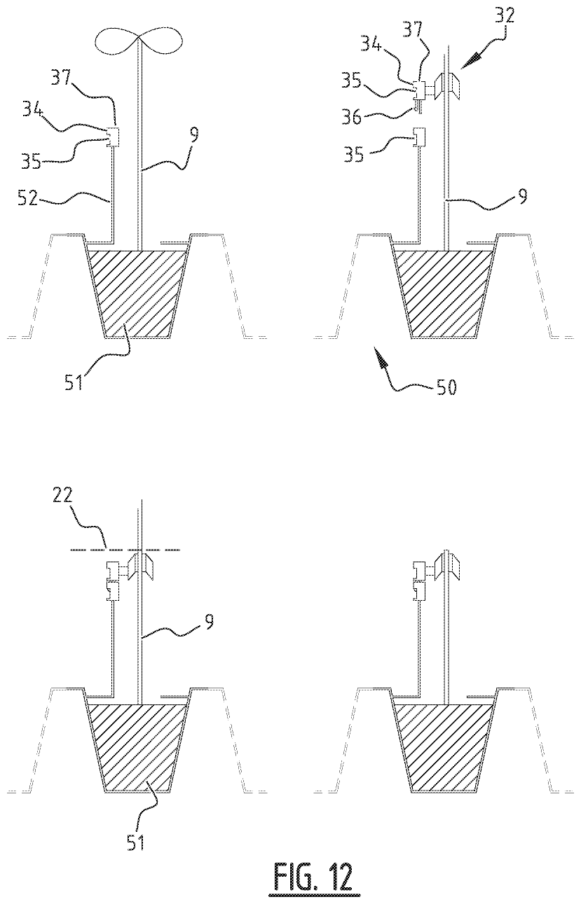

FIG. 12 shows a schematic representation of a strip or tray with an integrated or attachable grafting system.

Herein below, FIGS. 1-3 will be described together, followed by a sequential description of FIGS. 4-6, while the strips in FIGS. 1 and 2-6 respectively form distinct embodiments.

A graft system in the figures of the appended drawing is configured to graft plant material. More in particular, it is intended to provide a graft system that allows automation to avoid the cumbersome, labor intensive prior art technique, while increasing the graft success rate.

To this end the following graft system is provided.

In FIG. 1, a strip 1 is depicted, which comprises an array 2 of root accommodations 3. The root accommodations 3 are formed as boxes in side view, having open sides and openings 7 in top sides of the box shaped accommodations 3 to allow stems 9 of the plants to grow from the distinct accommodations 3. The accommodations 3 are to be filled with substrate and/or roots of plants.

Tray 5 may be used to insert array 2 of root accommodations 3 of strip 6, like the strip 1 of FIG. 1, in indentations 8 in tray 5.

Strip 6 of FIGS. 2-6 is distinct from strip 1 of FIG. 1 with respect to a number of features. In strip 1, accommodations 3 are in the array 2 of strip 1 interconnected by a rail 4. In the embodiment of FIGS. 2-6 accommodations may be interconnected at neighbouring shoulders 11 thereof as in strip 6. Interconnection allows automated processing/manipulation of arrays 2 of strip 1, 6. Further, in the embodiment of FIGS. 2-6, the interconnection of shoulders is elongate to extend long the length of strip 6 and to interconnect holders 12, while in strip 1 of FIG. 1, discrete holders 12 are provided. The holders are to be described in more detail below.

A strip 1, 6 may be inserted into tray 5, in the fashion shown in FIG. 2, and with more detail thereof in FIG. 3, with substrate in accommodations 3 and in indentations 8 of tray 5, to allow a young plant 10 to grow with a stem 9 thereof extending through the opening 7 of strip 1 or open top of strip 6. After a suitable period has passed, strip 1, 6 may be extracted from the tray 5. By appropriate handling of the strip 1, 6, dead and/or diseased plants 10 may be ejected from strip 1, 6 and removed plants may be replaced to allow a compact and useable fill of accommodations 3 of strip 1, 6. Additionally or alternatively, young plants 10 may be grouped depending on diameters of the stems thereof and based on such an order re-arranged in strip 1, 6. This allows for easy matching of stems to be grafted with corresponding diameters, whereas to large a diameter difference could result in a graft failing to take hold. Alternatively, stems to be grafted may be clamped, as described below, to within a tolerance of diameter differences to forcibly make the stems to be grafted match in diameter. Other suitable processing or handling may also take place in an automated process. Thereafter, the grafting process is implemented, as will be described herein below, based on FIGS. 4-6.

Strips 1, 6 respectively have discrete and interconnected holders 12. A plurality of holders 12 of strip 6 in FIGS. 2-6 are interconnected by a connection bar 15. This allows all holders 12 of strip 6 to be lifted together in an automated fashion, after cutting the stems 9, as will be described in more detail herein below. Likewise, in the embodiment of strip 1 in FIG. 1, each of the holders is connected to an individual connection bar 15.

Holders 12 of strip 1 in FIG. 1 may be lifted individually but still also in an automated fashion, after cutting the stems 9. This allows a selected graft to be combined with another individually selected one, and obviates a need for re-arranging the order of plants in strip 1, as would be preferred in the strip 6 of FIGS. 2-6, for matching stem 9 diameters or based on any other criterion.

Connection bar 15 connects a holder 12 to at least one carrier 16. Each carrier 16 is arranged on a top of a post 17, extending from an accommodation 3. Carrier 16 may be an integral part of post 17 and cut therefrom, when stems 9 are cut, or may be stacked on post 17 for easy lifting from post 17 without cutting a connection there between. Carriers 16 have a hole 18 in a top side thereof, as well as a rejuvenation 19 at the bottom, which fits into hole 18. Connection bar 15 connects holder 12 to two carriers 16 on opposite sides of holder 12 for stability and accurate position of holder 12. In an alternative embodiment, hole 18 and rejuvenation 19 could have a non-circular cross section, to ensure accurate positioning, such as rectangular, square, ellipsoid, et cetera. In such a case, a single carrier 16 for any one holder 12 may suffice.

Each holder 12 has lips 13, as shown in FIG. 3 in particular, extending from a through passage 14. The lips 13 form a guide for introducing a stem 9 into the holder 12. Pushing a stem 9 of a plant into the through passage 14, if necessary as the plant 10 can have grown through the through passage 14 on its own, will result no or very little (minimal) harm to stem 9 of plant 10.

Through passage 14 defines a clamp having a practically fixed diameter, to forcibly clamp a stem 9 to a predetermined diameter. Such diameters may vary for different types of plants 10. This clamping of stems 9 to size the stems to a predetermined diameter also allows obviating a need to match corresponding diameters of stems to be grafted.

Following the above disclosure of structural configurations of holders 12, an embodiment of a process of grafting is described below, which is based on the strip 6 embodiment of FIGS. 2-6. FIG. 4 shows two strips 6. In both strips 6 plants 10 are grown with roots thereof in substrate which could be encompassed by a plant position or indentation 8 in tray 5. The plants 10 in strip 6 on the left side in FIG. 4 are grown to approximately the depicted size, the stems are inserted into holders 12 (if necessary) and stems 9 are cut along a cut line 21 under carriers 16, together with posts 17 to liberate carriers 16 from the underlying portions of strip 6 for holders 12 to engage stems 9 with leafs thereon but without roots. Likewise, plants 10 in strip 6 on the right side in FIG. 4 are grown to approximately the depicted size, the stems are inserted into holders 12 (if necessary) and stems 9 are cut along a cut line 22 above holders 12, where carriers 16 remain connected with posts 17 and holders engage stems 9 with connected roots and without the leaves there above.

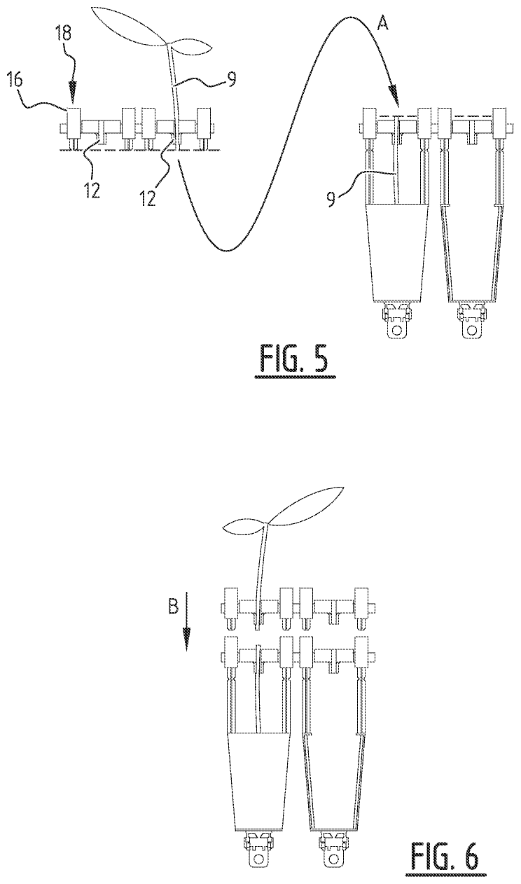

Consequently, as shown in FIG. 5, a liberated array of holders 12 with stems 9 from the strip 6 on the left in FIGS. 4, 5 and having leaves on top may be stacked along arrow A onto (arranged on top of) holders 12 holding or clamping stems 9 with roots still attached thereto in holders 12 of the other strip 6. To this end, rejuvenations 19 are inserted along arrow B in FIG. 6 into openings 18 in a top side of carriers 16, as indicated in FIG. 6. Thereby, stems 9 in the respective holders 12 are made to abut and are aligned, by appropriate dimensioning of the holders 12 and carriers 16. This allows the stems to grow attached and form a graft.

Thus the present disclosure provides first holder 12 configured to engage a stem 9 of a first plant 10, below a cutline 22 to hold a severed stem 9 and connected roots (rootstock) of the first plant 10, and second holder 12 configured to engage a stem 9 of a second plant 10, above a cut line 21 to hold a severed stem 9 and connected leaves (scion) of the second plant 10; wherein the second holder 12 is stackable on the first holder 12, to thereby abut and align the severed stems 9. In fact, in the above described embodiments, the stacking is achieved through the carriers 16, or a single carrier 16 per holders 12 or clamping through opening 14 may suffice, as indicated above. Alternatively, holders 12 may be stackable in the fashion attributed to the carriers 16.

In FIGS. 7-11 an alternative embodiment of a graft system 30 according to the present disclosure is shown. The graft system 30 comprises an elongate bar 31 with clamps 32 arranged at or near the ends of the bar 31. Each of the clamps 32 may be released from the bar 31 by breaking a selected one or both of the clamps 32 from the bar 31 at break line or break position 33. In FIG. 7, only the lowermost clamp 32 is broken free and swiveled in the direction of arrow C. This embodiment is symmetrical in the sense that it doesn't matter which clamp 32 is broken free from bar 31. Even if the uppermost clamp 32 is broken from bar 31, the remainder of bar 31 and clamp may simply be inverted, and the bar 31 may be inserted in substrate the right way up to enable an overlying clamp 32 to be coupled therewith.

The clamps 32 comprise a bus 34 with a barb hook 36 extending at one end, and an opening 37 for inserting a barb hook 36 of another clamp 32 at another end, as well as an opening 35 for hooking the barb hook 36 of the other clamp 32. Further, the clamps 32 define an input guide 39 for inserting stems of plants, which may be opened to allow insertion of stems 9 with a relatively large size in relation to the input passage defined in the input guide 39, by compressing flanges 38. A rib 40 is provided in the flanges 38 and backing the input guide 39, for force transfer to open guide 39.

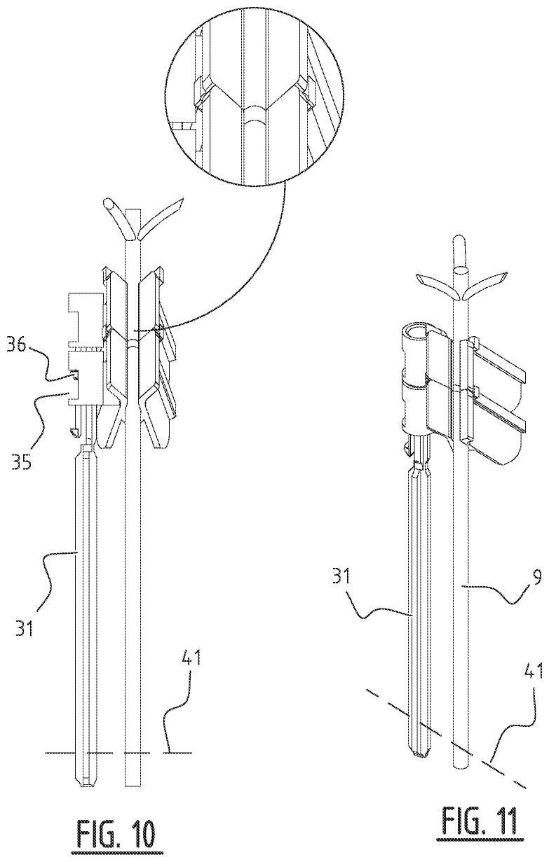

In the succession of steps depicted in FIGS. 7-11, the clamp 32 that has been broken free from bar 31, is attached to a stem of a first plant in the top half of FIG. 9 for rootstock removal therefrom along cut line 21. The other clamp 32 is attached to a stem of a second plant for scion removal therefrom along cut line 22. Then, as shown in FIG. 9, the clamp 32 with the scion of the first plant and the clamp 32 with the rootstock of the second plant are brought together, wherein, as shown in FIG. 10, barb hook 36 of the overlying bus 34 is introduced into hole 37 and hooks into hole 35 in lower bus 34. This provides a first contribution to abutment and alignment of the stems of the first plant and the second plant. A further contribution is provided by ribs 40, which are stepped to define an accommodation for the guide 39 of the overlying clamp 32, as shown in the detail of FIG. 10. FIG. 11 shows the end position of FIG. 10 in a perspective view, where the bar 31 may be inserted into substrate 41, to keep the coupled clamps 32 at the interface between the stems 9 of the first plant and the second plant.

To ensure proper abutment of the stems 9, the stem in overlying clamp 32 with plant scion is cut immediately under clamp 32, and the stem in underlying clamp 32 with rootstock is cut immediately over rib 40, defining the step for accommodating the guide 39 of the overlying clamp 32. As a consequence, stems are forcibly abutted in the situation of FIGS. 10, 11.

FIG. 12 shows a schematic representation of a strip or tray 50 with an integrated or attachable grafting system. The strip or tray 50 comprises plant positions in the form of depressions 51 for accommodating substrate and/or roots of plants. The plant positions are interconnected, as indicated with a dashed line in FIG. 12. However, from the left to the right in FIG. 12, subsequent grafting steps are disclosed.

In the left most plant position 51 of strip or tray 50, an upright 52 is attached to the strip or tray 50, or is integrally formed therewith. The upright extends from a side of plant position 51 towards a center thereof, and then bends upwards to a bus 34, much alike the bus 34 of the clamps 32 in the embodiment in FIGS. 7-11, and therefore indicated by the same reference sign. A clamp 32 (also much alike the clamps 32 of FIGS. 7-11) is in the second plant position from the left in FIG. 12 brought towards the bus 34 on the upright 52 and clicked thereto in the position of the third plant position from the left in FIG. 12, using barb hook 36, while the stem 9 of the plant is inserted in the clamp 36 via the guide 39. Thereafter, to keep the rootstock of the plant having its roots in the plant position, the stem 9 may be cut over the rib 40, along cut line 22, resulting in the situation at the rightmost plant position in FIG. 12. Thereafter, a clamp 32 with a scion (like the top half of FIG. 9) may be arranged in and on the bus 34 of the clamp 32 engaging the stem 9 with the rootstock (the same as in FIG. 10), which latter clamp 32 is then still supported by bus 34 on upright 52.

Evidently the present disclosure allow for many additional and/or alternative embodiments relative to those explicitly depicted in the appended drawings and described above in relation thereto. Consequently the scope of protection according to the also appended claims is by no means limited to the explicitly shown and described embodiments, but encompasses alternative and additional embodiments, even if not explicitly referred to, and also encompasses even obvious alternatives in certain jurisdictions for elements and components of the appended independent claims.

1. A graft system configured to graft plant material, comprising:
a first holder configured to engage a stem of a first plant, below a cutline to hold a severed stem and connected roots of the first plant; and
a second holder configured to engage a stem of a second plant, above a cut line to hold a severed stem and connected leaves of the second plant;
wherein the second holder is stackable on the first holder, to thereby abut and align the severed stems.

2. The graft system according to claim 1, wherein at least one of the first holder and the second holder comprises a stem compressing clamp.

3. The graft system according to claim 2, wherein a size of the stem compressing clamp is uniform for grafting any combination of the first plant and the second plant.

4. The graft system according to claim 1, wherein at least one of the first holder and the second holder is connected to a carrier.

5. The graft system according to claim 1, wherein at least one of the first holder and the second holder is releasably supported on one of a post and another holder.

6. The graft system according to claim 4, wherein at least one of the first holder and the second holder is releasably supported on one of a post and another holder; and wherein the carrier of the at least one of the first and second holder is supported on the one of the post and the other holder.

7. The graft system according to claim 4, wherein the at least one of the first and second holder is connected to two carriers.

8. The graft system according to claim 7, wherein the holder is arranged between the two carriers.

9. The graft system according to claim 1, manufactured at least partially from bio-degradable material.

10. The graft system according to claim 1, wherein the first holder and the and second holder comprise complementary coupling parts of a click or snap coupling.

11. A strip for accommodating plant material, the strip comprising:
an array of root accommodations; and
at least a portion of a graft system according to claim 1.

12. The strip according to claim 11, wherein at least one of the first holder and the second holder is releasably supported on one of a post and another holder; and wherein the post extends from at least one of the root accommodations.

13. The strip according to 11, wherein at least one of the first holder and the second holder is connected to a carrier; and wherein the at least one carrier is manufactured as an integral component of a post to be severed together with the stem.

14. An assembly of:
a tray, and one of:
a graft system comprising:
a first holder configured to engage a stem of a first plant, below a cutline to hold a severed stem and connected roots of the first plant; and
a second holder configured to engage a stem of a second plant, above a cut line to hold a severed stem and connected leaves of the second plant;
wherein the second holder is stackable on the first holder, to thereby abut and align the severed stems, and
a strip comprising:
an array of root accommodations; and
at least a portion of a graft system according to claim 1,
wherein the tray comprises plant positions defined by indentations configured to contain at least one of substrate and plant roots.
